(19) United States
(12) Patent Application Publication
(10) Pub. No.: US 2023/0212884 A1
(43) Pub. Date: Jul. 6, 2023

(54) LOCK WITH A CLUTCH DRIVING MECHANISM

(71) Applicant: DEZHAO XIANG, SHENZHEN (CN)

(72) Inventor: DEZHAO XIANG, SHENZHEN (CN)

(21) Appl. No.: 17/864,448

(22) Filed: Jul. 14, 2022

(30) Foreign Application Priority Data
Dec. 31, 2021 (CN) 202111667699.3
Dec. 31, 2021 (CN) 202123448948.8

(51) Int. Cl. E05B 59/00

(52) U.S. Cl. CPC E05B 59/00; F16D 11/16

(57) ABSTRACT

The present disclosure provides a lock with a clutch driving mechanism, comprising a driving input portion, a dutch component, a dead bolt driving component, a latch bolt driving component, a first end of the driving input portion is driven, and the second end is connected to the clutch component; a first end of the dutch component is driven, a second end drive one of the dead bolt driving component and the latch bolt driving component, a first end of the latch bolt driving component is driven in the second direction, a second end opens the door. The mechanism can simply realize the keyless mechanical double locking of the dead bolt while the latch bolt still remains in the normally open mode without using the key every time when locking the dead bolt, that key or motor drive is used only when the dead bolt double locking is to be released.

### CROSS REFERENCE OF RELATED APPLICATIONS

The present application claims priority of Chinese Application No. 202111667699.3 filed on Dec. 31, 2021, Chinese Application No. 202123448948.8 filed on Dec. 31, 2021, the entire contents of which are hereby incorporated by reference.

### TECHNICAL FIELD

The present disclosure relates to the technical field of locks, and in particularly to a lock with a clutch driving mechanism.

### BACKGROUND

A lock device is a device for locking a movable first object to a fixed second object to define a closed area, which generally includes a lock body, a key, and accessories thereof.

A typical lock includes a dead bolt for double locking and fixing of the lock body relative to the second object, and a latch bolt for general locking, which only protects from being blowed open by accident, such as by the wind etc. In this kind of lock, the key is usually used to realize the double locking of the dead bolt. That is, it requires to insert the key and turn it several turns to drive the dead bolt to extend outwardly, this double locking approach is troublesome to operate.

Therefore, how to provide a lock which is easy to operate has become a technical problem to be solved.

### SUMMARY

The technical problem to be solved by the present disclosure is how to realize convenient double locking of the lock.

For this purpose, the present disclosure discloses a lock with a clutch driving mechanism, comprising a driving input portion, at least one clutch component, a dead bolt driving component, and a latch bolt driving component, wherein the driving input portion comprises a first end accessible and drivable from an external side, and a second end connectable to the clutch component; the clutch component comprises a first end connected with the driving input portion, so as to be driven by the driving input portion, and a second end selectively connected with and drives the dead bolt driving component or the latch bolt driving component; the dead bolt driving component comprises a first end connected to the clutch component to receive a driving along a first direction, and a second end connected to the dead bolt and outputs a driving to the dead bolt to drive the dead bolt to extend outwardly, so as to lock a door with the dead bolt; the latch bolt driving component comprises a first end connected to the clutch component for receiving a driving in a second direction opposite to the first direction, and a second end connected to the latch bolt for outputting a driving to retract the latch bolt to open the door.

The present disclosure has the following beneficial technical effects:

The lock with a clutch driving mechanism disclosed by the embodiment of the disclosure is able to transmit different input actions of the two input components to the two output components respectively by means of the clutch driving mechanism. Therefore the locking, double locking and unlocking of the lock are respectively realized by different input actions.

### BRIEF DESCRIPTION OF THE DRAWINGS

FIG. 1 is a schematic perspective view of a lock with a clutch driving mechanism according to an embodiment of the present disclosure;

FIG. 2 is a schematic exploded perspective view of the lock shown in FIG. 1;

FIG. 3 is another exploded perspective view of the lock shown in FIG. 1 with a front housing removed;

FIG. 4 is another schematic exploded perspective view of the lock shown in FIG. 3;

FIG. 5 is a schematic perspective view of a clutch driving mechanism of the lock shown in FIG. 1;

FIG. 6a is a cross-sectional view of the clutch driving mechanism shown in FIG. 5, wherein the clutch driving mechanism is in a double locking state;

FIG. 6b is an another cross-sectional view of the clutch driving mechanism shown in FIG. 5 wherein the first driving member is driven to release the double locking;

FIG. 6c is a further cross-sectional view of the clutch driving mechanism shown in FIG. 5 with the second driving member being driven in a first direction to unlock the latch bolt;

FIG. 6d is a further cross-sectional view of the clutch driving mechanism shown in FIG. 5 in which the second driving member is driven in a second direction to achieve double locking;

FIG. 7a is another schematic perspective view of the clutch driving mechanism of the lock shown in FIG. 1 with a portion of the housing removed to show the internal structures, wherein the clutch driving mechanism is in a double locking state;

FIG. 7b is another schematic perspective view of the clutch driving mechanism of the lock shown in FIG. 1, with a part of the housing removed to show the internal structures, wherein the first driving member is driven to release the double locking;

FIG. 7c is another schematic perspective view of the clutch driving mechanism of the lock shown in FIG. 1, with a part of the housing removed to show the internal structures, wherein the second driving member is driven in a first direction to unlock the latch bolt;

FIG. 7d is another schematic perspective view of the clutch driving mechanism of the lock shown in FIG. 1 with a part of the housing removed to show the internal structures, wherein the second driving member is moved in a second direction to achieve double locking;

FIG. 8 is a schematic exploded perspective view of the rear portion of the lock shown in FIG. 1.

FIG. 9a is a schematic perspective view of a clutch driving mechanism according to another embodiment of the present disclosure, wherein a toggle piece is pressed down.

FIG. 9b is a further schematic perspective view of the clutch driving mechanism shown in FIG. 9a, wherein the toggle piece is lifted up.

FIG. 10a is a schematic perspective view of a dutch driving mechanism according to another embodiment of the present disclosure, wherein a toggle piece is lifted up,

FIG. 10b is a further perspective view of the clutch driving mechanism shown in FIG. 10a , wherein the toggle piece is pressed down.

FIG. 11 is an exploded view of another embodiment of the lock of the present disclosure.

FIG. 12 is a further exploded view of the lock shown in FIG. 11.

FIG. 13 is an enlarged view of portion A shown in FIG. 11

### DESCRIPTION OF THE EMBODIMENTS

In order to make the object, the technical solution and the advantages of the present disclosure more apparent, the present disclosure is described in further detail in conjunction with the accompanying drawings and embodiments. It should be understood that the described embodiments are made for the purpose of merely illustrating the present disclosure, but not intended to make any limitation.

In the description of the present disclosure, it should be noted that the orientation or positional relationship indicated by the terms “center,” “up,” “down,” “left,” “right,” “vertical,” “horizontal,” “inside,” “outside” and the like is based on the orientation or positional relationship shown in the drawings. Which are for ease of description of the disclosure and simplify the description, and are not intended to indicate or imply that the devices or elements referred to must have a particular orientation, be constructed and operate in a particular orientation. Therefore, they should not be construed as limitations of the present disclosure. In addition, the terms “first,” “second,” “third” are used for descriptive purpose only and cannot be interpreted as indicating or implying relative importance.

In the description of the present disclosure, it should be noted that the terms “installed”, “linked”, “connected” are to be understood in a broad sense, for example, it may be a fixed connection, a detachable connection, or an integral connection; it may be directly connected or indirectly connected through an intermediate medium. For a person skilled in the art, the specific meanings of the above-mentioned terms in the present disclosure can be understood according to the specific circumstances.

In addition, the technical features involved in the different embodiments of the present disclosure described below may be combined with each other as long as they do not constitute conflict with each other.

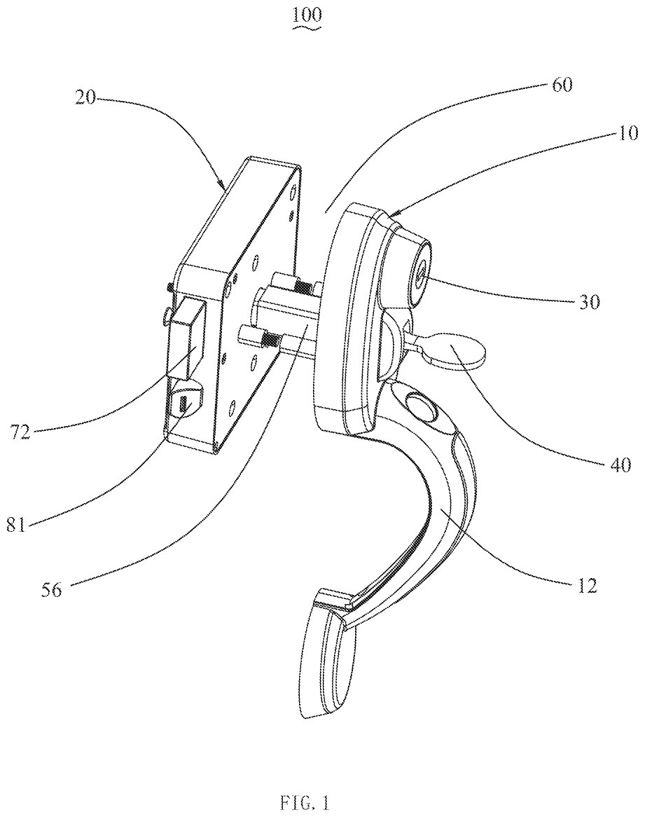

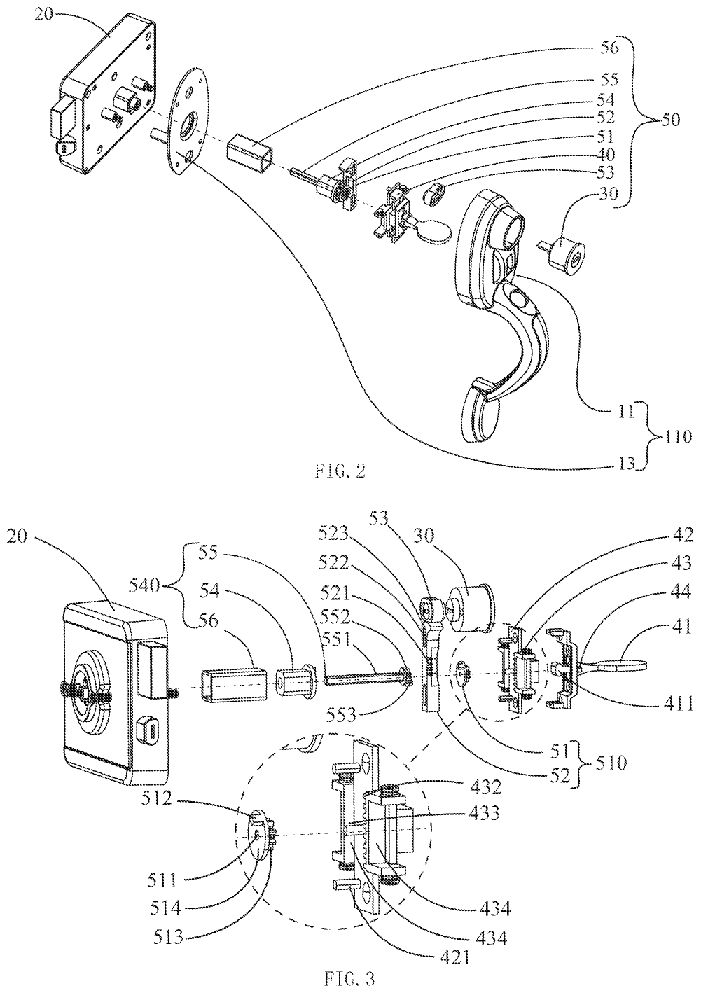

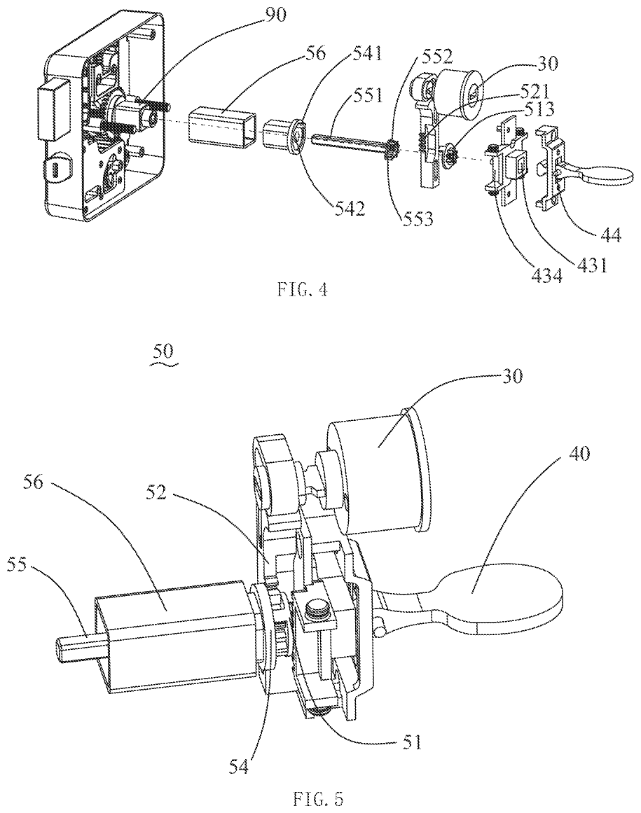

Referring to FIG. 1., FIG. 2 and FIG. 4, a lock 100 according to a first embodiment of the present disclosure includes a front portion 10 and a rear portion 20 with a space 60 defined therebetween for accommodating an object to be locked (not shown). The front portion 10 and the rear portion 20 are fixedly connected to the object to be locked, which may be, for example, a door, a window or the like. The front portion 10 includes a housing 110 and a clutch driving mechanism 50. The rear portion 20 includes a dead bolt 72. a latch bolt 81, and a drive receiving assembly 90. The clutch driving mechanism 50 includes a lock cylinder assembly 30, a toggle piece assembly 40, a driving component 510 and an output component 540. The driving action of the lock cylinder assembly 30 and the toggle piece assembly 40 by a user is converted by the driving component 510, and finally transmitted to the drive receiving assembly 90 of the rear portion 20 by means of the output component 540, to thereby drive the latch bolt 81 and the dead bolt 72 to extent out or retract in.

In this embodiment, the housing 110 of the front portion 10 includes a face case 11 and a back plate 13 which are fixedly connected to each other., and the face case 11 and the back plate 13 define a receiving space. Two openings communicating with the receiving space are opened in the face case 11 toward the outside, and a substantially arch-shaped handle 12 is provided at the lower portion of the face case 11. The clutch driving mechanism 50 is partially arranged within the receiving space. The lock cylinder assembly 30 includes a keyhole for insertion of a key. The toggle piece assembly 40 includes a toggle piece 41 which is used for a user to toggle. The keyhole and the toggle piece 41 extend through the two openings on the face case 11 respectively, so that the key hole and the toggle piece 41 can be operated from the outside.

Referring further to FIG. 3, the toggle piece 41 of the toggle piece assembly 40 is hinged to the face case 11 via a pin 44. One end of the toggle piece 41 located within the receiving space is provided with a toggle block 411. The other end of the toggle piece 41 outside the receiving space is configured as a plate sheet, so as to facilitate the user's operation, The toggle piece assembly 40 further includes a slider 43 and a guide frame 42. The guide frame 42 is fixedly connected to the face case 11. A sliding groove 431 is provided on a side of the slider 43 facing the toggle piece 41. The toggle block 411 is partially received in the sliding groove 431 and can drive the slider 43 move up and down by urging a wall of the sliding groove. On the other side of the slider 43 facing away from the toggle piece 41, a frame guide groove 433 for partially enclosing the guide frame 42 is provided, so that the slider 43 can be moved along the guide frame 42 by the toggle block 411. On the other side of the slider 43 facing away from the toggle piece 41, an input rack 432 is provided on one of two opposite side walls 434 which enclosing the guide frame 42. The longitudinal direction of the input rack is arranged along the vertical direction. The input rack 432 includes a plurality of teeth each of which has a tooth top facing the other side wall. The input rack 432 is used to transmit the displacement of the slider 43 to the driving component 510. In this embodiment, the pin 44 of the toggle piece assembly 40 is disposed in the horizontal direction, so that the toggle piece 41 can be moved in the vertical direction, thereby driving the slider 43 to move up and down in the vertical direction relative to the guide frame 42. In other embodiments, the setting angle of the pin 44 may be changed as desired, thereby changing the toggle angle of the toggle piece 41.

The driving component 510 includes a clutch component 51 disposed on a side of the guide frame 42 facing away from the toggle piece 41. The clutch component 51 comprises a substantially disk-shaped base plate 514, and a clutch pinion 513 for meshing with the input rack 432 is provided on a side of the base plate 514 facing the guide frame 42. A clutch block 512 is provided on a side of the base plate 514 facing away from the guide frame 42. The clutch block 512 is disposed on the end surface of the base plate 514 facing away from the guide frame 42 and protrudes from the end surface thereof in the axial direction. In the present embodiment, the clutch component 51 further includes a fixing hole 511 passing through the central portion of the clutch component 51 in the axial direction. The fixing hole 511 is used for rotatably fixing the clutch component 51 to a positioning pin on the guide frame 42.

The driving component 510 further includes an unlocking transmission member 52, which is substantially in the shape of an elongated bar, with two elongated guiding grooves 522 corresponding to guiding posts 421 of the guiding frame 42 provided thereon. The unlocking transmitting member 52 can be disposed on the inner side of the guide frame 42, and the guide posts 421 are inserted into the guide grooves 522 to guide the unlocking transmission member 52 to move relative to the guide frame 42 in the vertical direction. The upper end of the unlocking transmission member 52 is provided with a guiding portion 523 protruding upward in an arc shape. On a side of the lock cylinder assembly 30 which faces the inner side of the lock, an input toggle block 53 is provided thereon. The input toggle block 53 has a shape of substantially an elongated bar. The input toggle block 53 can be driven by the lock cylinder assembly 30 to rotate. When one end of the input toggle block 53 is rotated to contact the guiding portion 523 of the unlocking transmission portion 52, a pushing force is exerted onto the unlocking transmission member 52 at a certain angle along the contact surface, so as to push the guiding portion 523 to move downwardly. For this reason, the portion where the input toggle block 53 contacts the guiding, portion 523 is preferably formed into a circular arc shape. A driving rack 521 is provided on a side of the unlocking transmission member 52 which faces the clutch component 51, and the driving rack 521 is used for driving the output component 540.

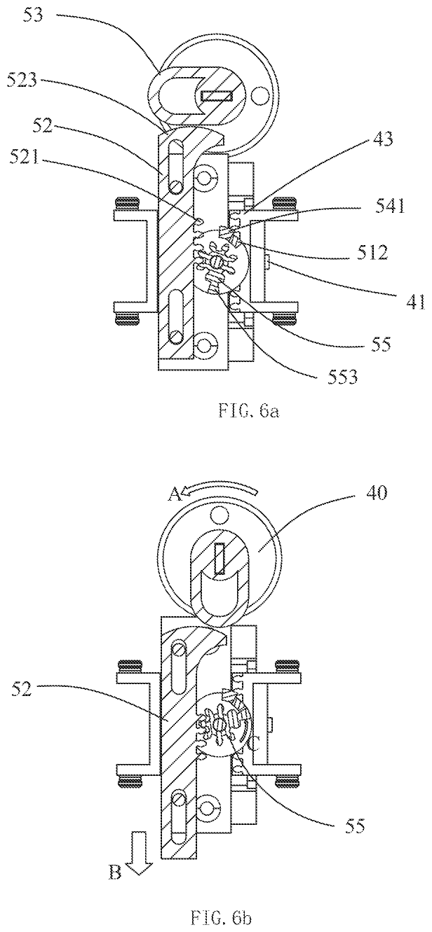

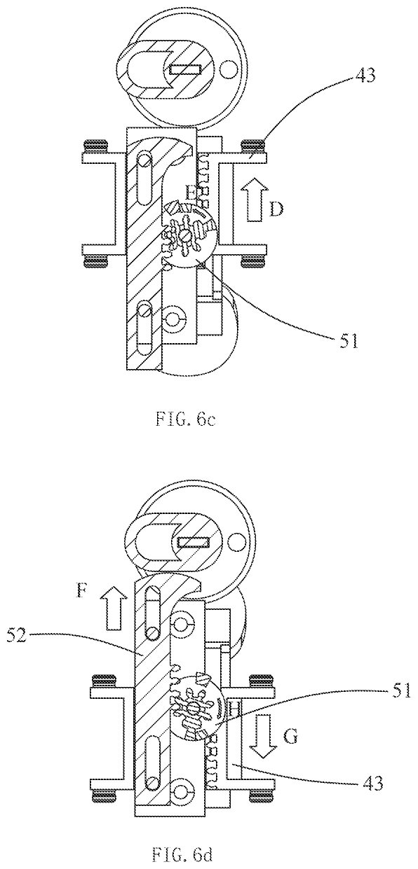

The output component 540 includes a dead bolt driving component 55, a latch bolt driving component 54 and a sleeve 56 which are arranged coaxially with the clutch component 51. The dead bolt driving component 55 includes a drive shaft 551, the drive shaft includes a square cross-section. One end of the drive shaft 551 facing the driving component 510 is provided with a transmission gear 553, and the transmission gear 553 can be engaged with the driving rack 521 An outer periphery of the transmission gear 553 is provided with a first transmission block 552 protruding radially outward. The latch bolt driving component 54 has a through hole 542 axially extending therethrough. The drive shaft 551 penetrates through the through hole 542 and is connected with the drive receiving assembly 90 of the rear portion 20. On the outer periphery of one end of the latch bolt driving component 54 which faces the rear portion 20, a drive portion having a square shape is provided. On one end of the latch bolt driving component 54 which faces the driving component 510, a second transmission block 541 which protrudes in the axial direction is provided. thereon. The clutch block 512 of the clutch component is disposed between the first transmission block 552 and the second transmission block 541 along the circumferential direction (see FIG. 6a). The sleeve 56 substantially configured as a square sleeve, and the inner side of the sleeve 56 is shaped to form-fit with the drive portion of the latch bolt driving component 54, such that the rotation of the latch bolt driving component 54 can drive the sleeve 56 to rotate. The other end of the sleeve 56 which faces away from the front portion 10 is used for connection with. the drive receiving assembly 90 of the rear portion 20.

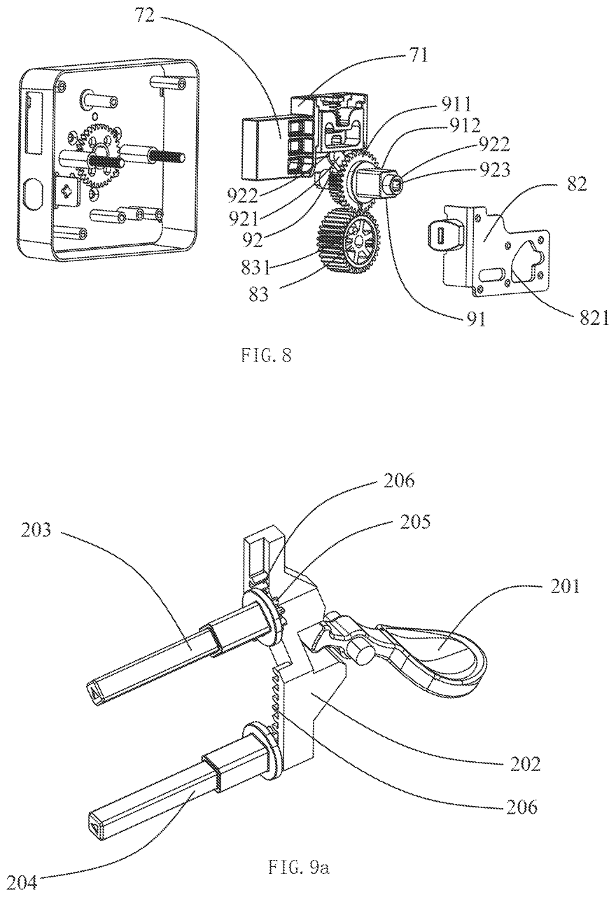

Referring to FIG. 8, the rear portion 20 includes a dead bolt assembly 70, a latch bolt assembly 80, and a drive receiving assembly 90. The drive receiving assembly 90 includes a first receiving portion 92 and a second receiving portion 91. The dead bolt assembly 70 includes a dead bolt 72 and a dead bolt slider 71. The latch bolt assembly 80 includes a latch bolt 81, a latch bolt driving member 82 fixedly connected with the latch bolt 81, and a latch bolt driving gear 83. The latch bolt 81 and the dead bolt 72 can be extended or retracted respectively from the two openings on the side of the rear portion 20. The first receiving portion 92 includes a receiving shaft 922 and an output toggle block 921. The second receiving portion 91 includes an engage receiving portion 912, that is in the shape of a square column and extends in the axial direction, and an output gear 911 disposed at one end of the engage receiving portion 912, a through hole which penetrates through the second receiving portion 91 in the axial direction. One end of the receiving shaft 922 of the first receiving portion 92 which faces the front portion 10 is also provided with a receiving opening 923. The receiving shaft 922 penetrates through the through hole such that the receiving opening 923 faces towards the drive shaft 551, and the receiving opening 923 is able to be form-fitted with the drive shaft 551. The sleeve 56 can be mounted around the outer periphery of the engage receiving portion 912 of the second receiving portion 91, and form-fit with the engage receiving portion 912. The first receiving portion 92 and the second receiving portion 91 are rotatable relative to each other. Thus, the rotations of the dead bolt driving component 55 and the latch bolt driving component 54 are able to respectively drive the first receiving portion 92. and the second receiving portion 91 to rotate.

The first receiving portion 92 is used for driving the dead bolt assembly 70. The output toggle block 921 of the first receiving portion 92 can extend into a groove 922 of the dead bolt slider 71, so that the rotation of the output toggle piece 921 can drive the dead bolt slider 71 to move, thereby controlling the extension and contraction of the dead bolt 72. Similarly, the second receiving portion 91 is for driving the latch bolt assembly 80. The output gear 911 of the second receiving portion 91 is engaged with the latch bolt driving gear 83 of the latch bolt assembly 80, so that the rotation of the second receiving portion 91 can drive the latch bolt driving gear 83 to rotate. The side surface of the latch bolt driving gear is provided with a driving pin 831, the latch bolt driving member 82 is provided with a drive opening 821, the driving pin 831 can extend into the drive opening 821. The drive opening 821 includes a driving side walls When the latch bolt driving gear 83 rotates, the driving pin 831 is able to move along the driving side walls and drive the latch bolt driving member 82 to move to extend or retract, thereby controlling the extension and retraction of the latch bolt 81. Preferably, the latch bolt assembly include a reset mechanism, which may for example include a spring or torsion spring with one end connected to the latch bolt assembly, and the other end connected to the housing, or an automatic reset device driven by a motor, etc. Additionally or alternatively, the dead bolt assembly include a reset mechanism which may for example include a spring or torsion spring with one end connected to the dead bolt assembly, and the other end connected to the housing, or an automatic reset device driven by a motor, etc.

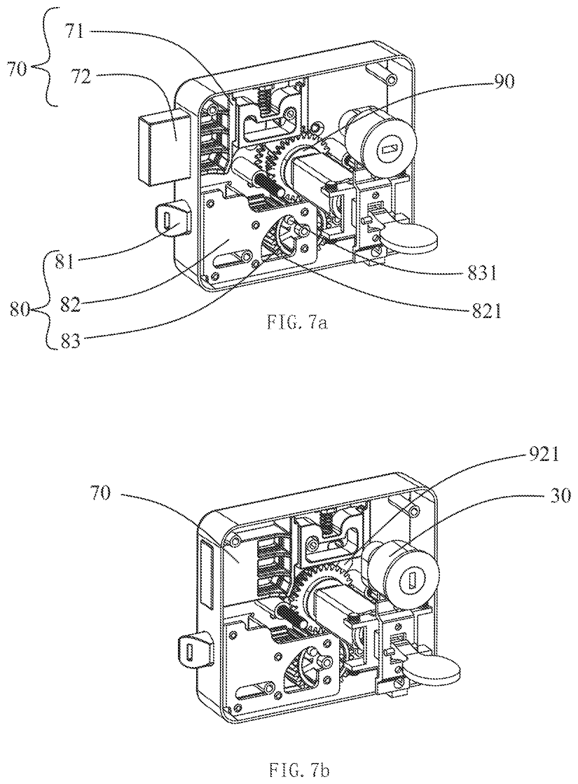

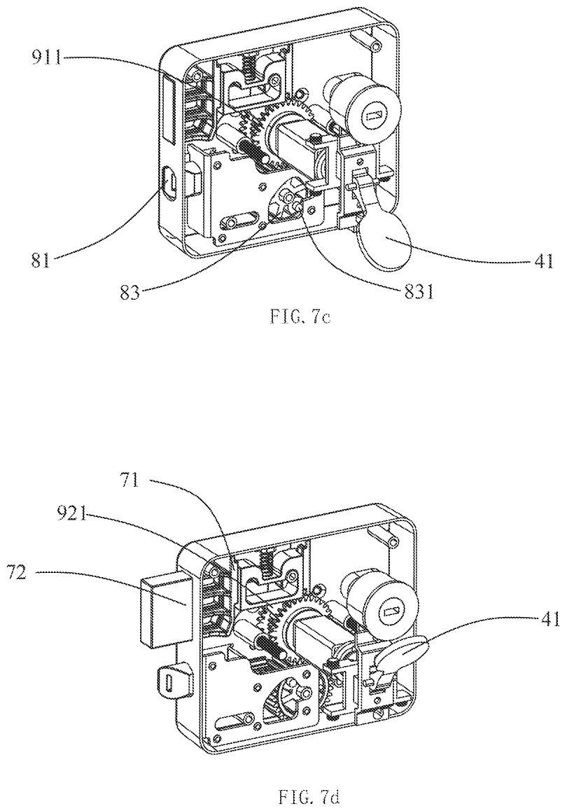

Referring to FIG. 5 to FIG. 7d, the operation process of the first embodiment of the present disclosure will be described with reference to the drawings. FIGS. 6a and 7a illustrates the initial state of the lock of the first embodiment of the present disclosure during the double locking process. In this regard, the double locking may comprise dead locking, which means that locking the deadbolt of the lock so that the locked object must be opened by a key or other authentication methods such as fingerprints. The clutch block 512 is located between the first transmission block 552 and the second transmission block 541. The first transmission block 552, the second transmission block 541 and the unlocking transmission member 52 are at their initial positions. FIGS. 6b and 7b illustrates the lock according to this embodiment in a state that the double locking is being released by means of the key. After the user inserts the key into the lock cylinder assembly 30 and rotates the key, the lock cylinder assembly 30 drives the input toggle block 53 to rotate to the position shown in the FIG. 6b along the direction A. The input toggle block 53 pushes the unlocking transmission member 52 along the direction B, so that the driving rack 521 on the unlocking transmission member 52 drives the transmission gear 553 of the dead bolt driving component 55 to rotate along the direction C, thereby driving the first receiving portion 92 to rotate and thus the bolt 72 to retract. FIGS. 6c and 7c show a state in which the lock according to this embodiment is driven by the toggle piece 41 to retract the latch bolt 81. After the user press the toggle piece 41 downwardly, since the toggle piece 41 is hinged to the face case 11, the toggle block 411 at the other end of the toggle piece 41 pushes the slider 43 along the direction D. The input rack 432 on the slider 43 drives the clutch pinion 513 on the clutch component to rotate in an direction E, and then the clutch block 512 pushes the second transmission block 541 to rotate in the direction F. In turn, the second receiving portion 91 is rotated by the latch bolt driving component 54 to retract the latch bolt 81. FIGS. 6d and 7d has shown a state of the lock of the present embodiment in which the lock is being actuated by the toggle piece 41 to realize double locking. After the user drives the toggle piece 41 upwardly, as the toggle piece 41 is hinged to the face case 11, the toggle block 411 at the other end of the toggle piece 41 pushes the slider 43 in a direction G. The input rack 432 on the slider 43 drives the clutch pinion 513 on the clutch component to rotate in a direction H, and the clutch block 512 pus hes the first transmission block 552 to rotate in the direction H, thereby driving the first receiving portion 92 to rotate and drive the dead bolt 72 to extent outwardly to realize the double locking. Simultaneously, the transmission gear 553 of the dead bolt driving component 55 also drives the driving rack 521 of the unlocking transmission member 52 in a direction F to return to its initial position.

In the embodiment described above, by using the lock cylinder assembly 30 as an unlocking portion and the toggle piece assembly 40 as a driving input portion, the rotation of the unlocking portion is converted into the rotation of the dead bolt driving component 55 in the first direction, and the upward and downward movements of the driving input portion are respectively converted into the rotation of the dead bolt driving component 55 in the second direction and the rotation of the latch bolt driving component 54 in the first direction, which further realizes the double locking and unlocking of the dead bolt of the lock, and the extending outwardly of the latch bolt of the lock.

It can be understood that, in other embodiments not shown, the unlocking portion, the driving input portion, the driving component, the dead bolt driving component, the latch bolt driving component can adopt other forms. For example, the unlocking portion and the driving input portion may be provided as coaxially arranged and relatively rotatable parts, or the dead bolt driving component and the latch bolt driving component may be provided separately from each other and arranged in parallel, instead of being arranged in a coaxial manner. Alternatively, the dead bolt driving component can be mounted around. the radially outer side of the latch bolt driving component, etc. The clutch component and the unlocking transmission member, or one of the clutch component and the unlocking transmission member can also be arranged coaxially or in parallel with the unlocking portion and the driving input portion. That is, the dead bolt driving component, the latch bolt driving component and the clutch component are arranged in the same direction along their respective axial directions, the clutch component and the unlocking transmission member can be respectively driven by the unlocking portion and the driving input portion to rotate in different directions. Alternatively, the transmission between the clutch component and the dead bolt driving component or the clutch component and the latch bolt driving component may be configured in a manner of rack-and-pinion engagement. Further, in addition of using a rack-and-pinion engagement for transmission, a lever type, a bouncing type, a prizing type transmission can also be used between the clutch component and the driving input portion, or between the clutch component and the dead bolt driving component, or between the clutch component and the latch bolt driving component.

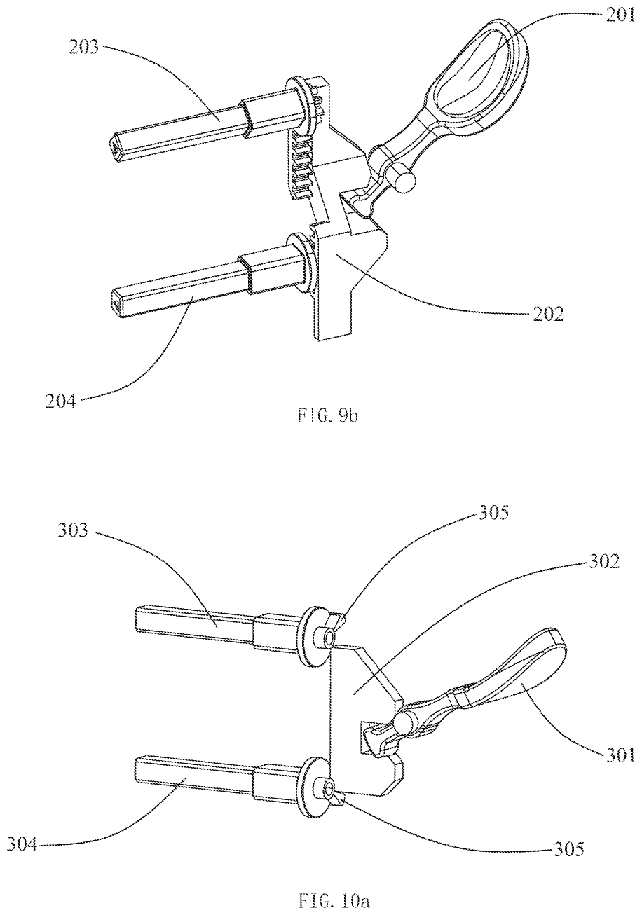

Referring to FIG. 9a and FIG. 9b, an alternative clutch driving mechanism of the lock 100 according to the present disclosure is shown, This clutch driving mechanism is used in combination with the other components of the lock as described in the above embodiment, which will not be repeat again. In the present embodiment, the clutch driving mechanism includes a toggle piece 201, a clutch component 202, a dead bolt driving component 203 and a latch bolt driving component 204. The toggle piece is hinged to the lock housing in a manner similar to the embodiment described above, and one of its ends which faces towards the interior of the lock extends into the groove of the clutch component 202 to drive the clutch component to move 202 up and down. The clutch component 202 includes two gear racks 206 arranged opposite to each other toward the inside and arranged in a vertical direction. The axial ends of the dead bolt driving component 203 and the latch bolt driving component 204 facing the clutch component 202 each include a gear 205. Each rack 206 is in mesh with a respective gear 205, therefore, the up-and-down movement of the toggle piece 201 can be converted into rotations of the dead bolt driving component 203 and the latch bolt driving component 204 by the clutch component 202, thereby driving the dead bolt and the latch bolt to move respectively. The dead bolt driving component 203 and the latch bolt driving component 204 each have a drive shaft, which are arranged parallel to each other.

In the above embodiments, only one clutch component is provided, it should be understood that, in other embodiment, the clutch component may be arranged with a plurality of clutch components arranged coaxially or non-coaxially, as long as the clutch component can be driven by the input driving portion to drive the dead bolt driving component and the latch bolt driving component, respectively.

In a further preferred embodiment, a limit mechanism may be provided in the rotate direction of the unlocking portion and the driving input portion or one of the unlocking portion and the driving input portion, so that the latter two are brought into contact with each other. The unlocking portion and the drive input portion are each rotatable independently relative to the other in a first rotational direction. The rotation of the unlocking portion in a second direction can drive the drive input portion to rotate together. Thereby, a possibility of achieving convenient operation is provided.

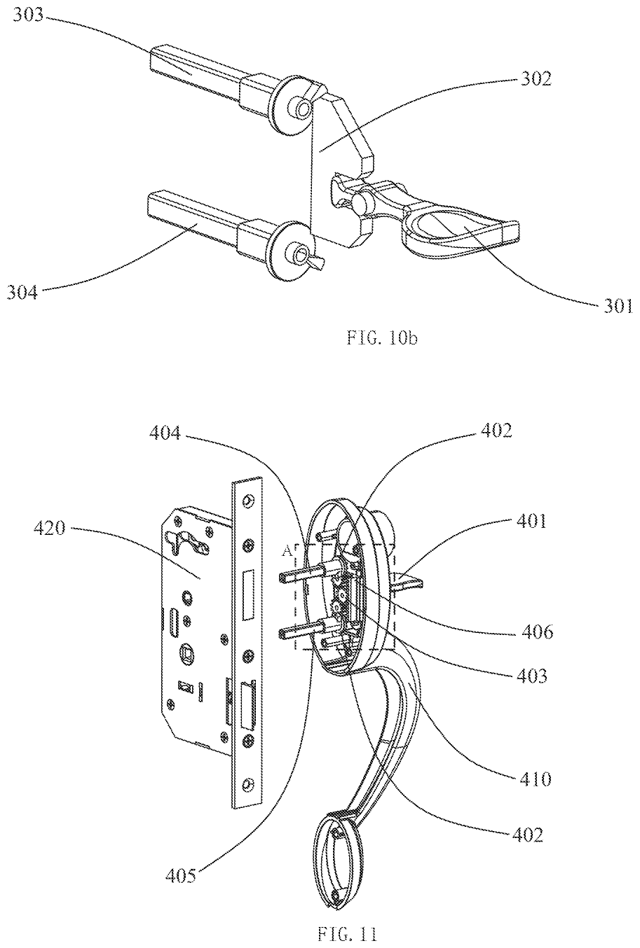

Referring to FIGS. 10a to 10b, an alternative clutch driving mechanism is provided. Similarly, this clutch driving mechanism is used in combination with the other components of the lock as described in the above embodiment, which will not be repeat again. In this embodiment, the clutch component 302 is disposed at the end of the drive input 301. on the side facing the dead bolt driving component 303 and the latch bolt driving component 304. The dead bolt driving component 303 and the latch. bolt driving component 304 each include a transmission block 305 that can be driven by the clutch component located at the end of the drive input 301. After being operated by the user with the driving input portion 301, the dead. bolt driving component 303 and the latch bolt driving component 304 can move along the driving and moving direction of the clutch component 302 respectively. Under the premise of achieving the above functions, the clutch component may be arranged in other forms as long as the clutch component is arranged to be capable of translation or rotation when driven by the input driving component, the dead bolt driving component and the latch bolt driving component can both be driven by the translation or rotation of the clutch component.

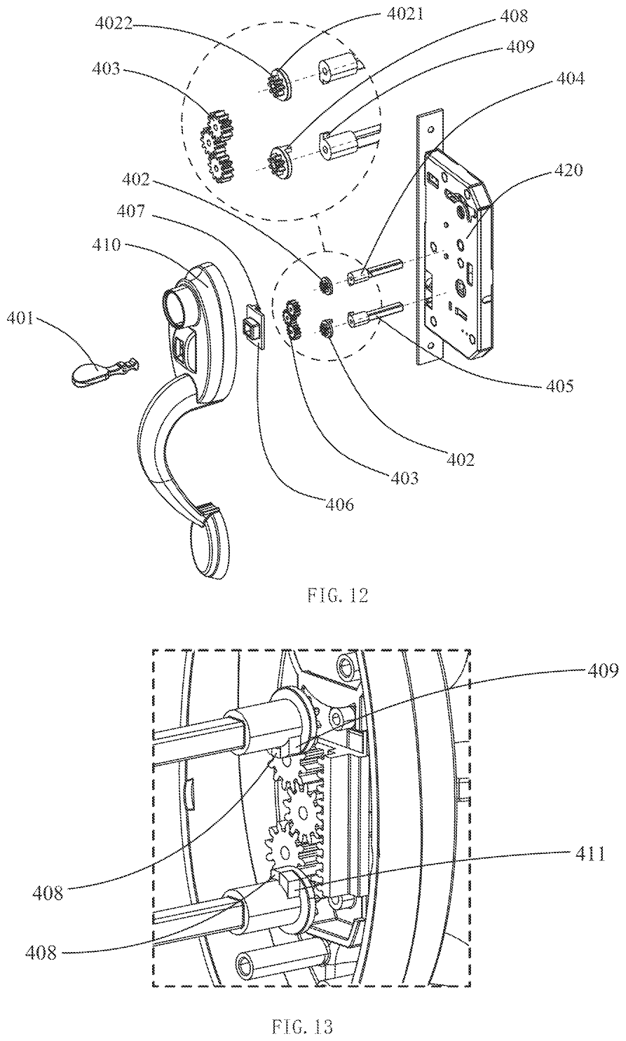

With referring to FIGS. 11 to 13, an alternative lock according to another embodiment is shown. The lock includes a dead bolt driving component 404, a latch. bolt driving component 405 arranged in parallel, two clutch driving components 402, a clutch gear set 403, a slider 406, a toggle piece 401, a front housing 410 and a rear housing 420. The dead bolt driving component 404 and the latch bolt driving component 405 each include a drive shaft arranged at one end of its own axial direction and a transmission block disposed at the other end opposite to the driving shaft and protruding in the radial direction. The dead bolt driving component 404 includes a dead bolt transmission block 409, and the latch bolt driving component 405 includes a latch bolt transmission block 411. The two clutch driving components 402 each comprises a substantially disc-shaped base plate 4021, one axial end of which is provided with a gear 4022, and the other axial end is provided with a clutch block 408 protruding axially at a circumferential edge. The two clutch blocks 408 are respectively arranged to be able to abut against the dead bolt transmission block 409 of the dead bolt driving component 404 and the latch bolt transmission block 411 of the latch bolt driving component 405 when rotating, so as to respectively drive the dead bolt driving component 404 and the latch bolt transmission block 411 to rotate. The toggle piece 401 is hinged to the face case 410, and one end of the toggle piece 401 is formed into a sheet shape that is easy to operate, and the other end thereof is formed as a driving portion adapted to engage with the slider 406 to drive the slider 406 to move. One side of the slider 406 is connected with the driving portion, the other side is provided with a driving rack 407 for driving the clutch gear set 403. In this embodiment, the clutch gear set 403 includes three gears, wherein the gear arranged in the middle is engaged with the driving rack 407 on one side, and engage with the remaining two gears on the other side. The remaining two gears are respectively engaged with the gears 4022 on the two clutch driving components 402. Thus, the movement of the slider 406 will be converted into the rotation of the clutch component 402, and the rotation of the clutch component 402 is respectively transmitted to the dead bolt driving component 404 and the latch bolt driving component 405 via the clutch block 408. Wherein in the initial position, the clutch block 408 corresponding to the dead bolt driving component 404 is disposed. at a first side in a first circumferential side of the dead bolt transmission block 409. The clutch block 408 corresponding to the latch bolt driving component 405 is disposed on a second circumferential side of the latch bolt transmission block 411. Wherein said first circumferential side is opposite to the first circumferential side. This allows the user to drive the clutch component 409 to rotate by toggling the toggle piece 401, so as to respectively drive the dead bolt driving component 404 and the latch bolt driving component 405 to rotate. Then the latch bolt and the dead bolt are respectively driven to move by means of the dead bolt driving component 404 and the latch bolt driving component 405.

By means of the present disclosure, the dead bolt keyless mechanical double locking of the lock can be simply achieved, while the latch bolt still remains in the normal open state without using the key every time the dead bolt is being double locked. A key or a motor drive is use only when the dead bolt double locking is being released, which ensures that the dead bolt keyless double locking is realized while the latch bolt of the lock remains in the normally open mode. On the premise of ensuring the safety of the lock, the function greatly reduces the time required for double locking, and the operation is simple and convenient and conforms to the usage habits of users.

It is to be understood that the above-described embodiments are merely examples for clarity of description and are not intended to limit the implementation. It will be apparent to those of ordinary skill in the art that other variations or variations in various forms may be made on the basis of the above description. All embodiments need not be and cannot be exhaustive here. The obvious changes or changes thus induced are still within the scope of protection of the disclosure.

What is claimed is:

1. A lock with a clutch driving mechanism, comprising a driving input portion, at least one clutch component, a dead bolt driving component, and a latch bolt driving component, wherein the driving input portion comprises a first end accessible and drivable from an external side, and a second end connectable to the clutch component;
the clutch component comprises a first end connected with the driving input portion, so as to be driven by the driving input portion, and a second end selectively connected with and drives the dead bolt driving component or the latch bolt driving component;
the dead bolt driving component comprises a first end connected to the clutch component to receive a driving along a first direction, and a second end connected to the dead bolt and outputs a driving to the dead bolt to drive the dead bolt to extend outwardly, so as to lock a door with the dead bolt;
the latch bolt driving component comprises a first end connected to the clutch component for receiving a driving in a second direction opposite to the first direction, and a second end connected to the latch bolt for outputting a driving to retract the latch bolt to open the door.

2. The lock with a clutch driving mechanism according to claim 1, wherein the at least one clutch components comprises exactly one clutch component.

3. The lock with a clutch driving mechanism according to claim 1, wherein the dead bolt driving component and the latch bolt driving component are arranged in parallel.

4. The lock with a clutch driving mechanism according to claim 2, wherein the clutch component drives the dead bolt driving component to move when the clutch component moves or rotates along a first direction, or drive the latch bolt driving component to move when the clutch component moves or rotates along a second direction.

5. The lock with a clutch driving mechanism according to claim 1, wherein the lock further comprises an unlocking transmission member and an input toggle block, the input toggle block drives the unlocking transmission member and thus the dead bolt driving component to move, so as to unlock the door locked by the dead bolt and drives the unlocking transmission member to move to an initial position.

6. The lock with a clutch driving mechanism according to claim 5, wherein the unlocking transmission member comprises a driving rack, the dead bolt driving component comprises a transmission gear which engages with the driving rack, when the dead bolt driving component is driven to move in a first direction, the unlocking transmission member is driven to move to the initial position by means of the engagement of the driving rack and the transmission gear.

7. The lock with a clutch driving mechanism according to claim 1, wherein one of the dead bolt driving component and the latch bolt driving component comprises a drive shaft, the other one of the dead bolt driving component and the latch bolt driving component is at least partially mounted around the drive shaft.

8. The lock with a clutch driving mechanism according to claim 1, wherein at least one of i), ii), and iii) comprises a rack-and-pinion mechanism for transmitting a driving movement: i) the clutch component and the driving input portion, ii) the clutch component and the dead bolt driving component, and iii) the clutch component and the latch bolt driving component.

9. The lock with a clutch driving mechanism according to claim 1, wherein the driving input portion comprises an input rack, and the clutch component comprises a clutch pinion engaged with the input rack.

10. The lock with a clutch driving mechanism according to claim 9, wherein the dead bolt driving component and the latch bolt driving component each comprising a transmission block, when the clutch component moves along a first direction, the clutch component drive the transmission block of the dead bolt driving component to move, when the clutch component moves along a second direction, the clutch component drive the transmission block of the latch bolt driving component to move.

11. The lock with a clutch driving mechanism according to claim 1, wherein the dead bolt driving component and the latch bolt driving component each comprise a drive shaft, the drive shaft of the dead bolt driving component and the drive shaft of the latch bolt driving component are arrange in parallel.

12. The lock with a clutch driving mechanism according to claim 11, wherein at least one clutch component comprises a first clutch component and a second clutch component, the driving input portion comprises two input racks, the two input racks drives the first clutch component and the second clutch component respectively, to thereby drive the dead bolt driving component and the latch bolt driving component respectively.

13. The lock with a clutch driving mechanism according to claim 11, wherein the clutch component is formed as one single piece which moves linearly along a first direction to approach and drive the dead bolt driving component and moves linearly along a second direction to approach and drive the latch bolt driving component.

14. The lock with a clutch driving mechanism according to claim 11, wherein the lock further comprises a first clutch component and a second clutch component, the dead bolt driving component and the latch bolt driving component each comprises a toggle block, the first clutch component drives the toggle block of the dead bolt driving component to move, and the second clutch component drives the toggle block of the latch bolt driving component to move, so as to drive the dead bolt driving component and the latch bolt driving component to move respectively.

15. The lock with a clutch driving mechanism according to claim 11, wherein the driving input portion comprises a toggle piece assembly, the toggle piece assembly comprises a toggle piece, a guide element, and a slider driven by the toggle piece and moves along the guide element, the slider drives the clutch component to move in two different directions.

16. The lock with a clutch driving mechanism according to claim 15, wherein the slider is provided with an input rack, and the clutch component is provided with a clutch pinion engaged with the input rack.

17. The lock with a clutch driving mechanism according to claim 11, wherein the lock further comprises a slider and a clutch gear set, the at least one clutch component comprises a first clutch component and a second dutch component, the slider comprises a rack that engages and drives the clutch gear set, each of the first clutch component and the second clutch component includes a gear that engages with the dutch gear set, and the clutch gear set drives the first clutch component and the second clutch component to move respectively by means of its engagement with the first clutch component and the second clutch component.

18. The lock with a clutch driving mechanism according to claim 1, wherein the clutch component is disposed at an end of the driving input portion, the dead bolt driving component and the latch bolt driving component each include a transmission block driven by the clutch component, the driving input portion drives the clutch component to move, so as to selectively drive the dead bolt driving component and the latch bolt driving component to move by means of the transmission block.

19. The lock with a clutch driving mechanism according to claim 1, wherein the clutch component, the dead bolt driving component and the latch bolt driving component are coaxial arranged, one of the dead bolt driving component and the latch bolt driving component is provided with a first transmission block protruding radially outward; one side of the clutch component is provided with a clutch block that protrudes towards the dead bolt driving component and the latch bolt driving component in an axial direction, a second transmission block protruding axially toward the clutch component is disposed on the other one of the dead bolt driving component and the latch bolt driving component, wherein the clutch block is disposed between the first transmission block and the second transmission block in the circumferential direction.

20. The lock with a clutch driving mechanism according to claim 1, wherein the lock further comprises a first receiving portion, a second receiving portion and a sleeve, the first receiving portion comprises a receiving opening that forms an torque-proof connection with the dead bolt driving component, and the second receiving portion comprises an outer edge that forms an torque-proof connection with the latch bolt driving component by means of the sleeve.
